(19) United States
(12) Patent Application Publication
(10) Pub. No.: US 2023/0068744 A1
(43) Pub. Date: Mar. 2, 2023

(54) SPACER COMPRISING AN INTERRUPTED ADHESIVE LAYER

(71) Applicant: SAINT-GOBAIN GLASS FRANCE, COURBEVOIE (FR)

(72) Inventors: Erol-Ertugrul SACU, STOLBERG (DE); David JANSSEN, TÖNISVORST (DE); Florian CARRE, ÜBACH-PALENBERG (DE); Svenja BOURONE, AACHEN (DE)

(21) Appl. No.: 17/794,507

(22) PCT Filed: Jan. 18, 2021
(86) PCT No.: PCT/EP2021/050922

§ 371 Date: Jul. 21, 2022

(30) Foreign Application Priority Data
Jan. 28, 2020 (EP) 20154037.4

(51) Int. Cl. E06B 3/673; B32B 7/14; E06B 3/663; C09J 7/29; C09J 7/30

(52) U.S. Cl. CPC E06B 3/67343; B32B 7/14; E06B 3/66314; E06B 3/66352; C09J 7/29; C09J 7/30; B32B 5/02

(57) ABSTRACT

A spacer for insulating glass units, includes a polymeric hollow profile extending in the longitudinal direction and including a first and second side wall, a glazing interior wall connecting connects the side walls to one another; an outer wall arranged substantially parallel to the glazing interior wall and connects the side walls to one another; a cavity surrounded by the side walls, the glazing interior wall, and the outer wall, a moisture barrier on the first side wall, the outer wall, and the second side wall of the polymeric hollow body, wherein the moisture barrier include a multi-layer system having a barrier function including a polymeric layer and an inorganic barrier layer, a metallic or ceramic outer adhesive layer, wherein the adhesive layer has a thickness d of at least 5 nm, the adhesive layer is interrupted in the transverse direction by uncoated regions.

The invention relates to a spacer for insulating glass units, an insulating glass unit, and use thereof.

Insulating glazings usually contain at least two panes made of glass or polymeric materials. The panes are separated from one another via a gas or vacuum space defined by the spacer. The thermal insulation capacity of insulating glass is significantly greater than that of single-plane glass and can be even further increased and improved in triple glazings or with special coatings. Thus, for example, silver-containing coatings enable reduced transmittance of infrared radiation and thus reduce the cooling of a building in the winter.

In addition to the nature and the structure of the glass, the other components of an insulated glass unit are also of great significance. The seal and especially the spacer have a major influence on the quality of the insulating glazing. In an insulating glazing, a circumferential spacer is fixed between two glass panes such that a gas-filled or air-filled inner interpane space is created, which is sealed against the penetration of moisture. and provides the thermal insulating properties.

The thermal insulating properties of insulating glazings are quite substantially influenced by the thermal conductivity in the region of the edge seal, in particular of the spacer. In the case of metallic spacers, the high thermal conductivity of the metal causes the formation of a thermal bridge at the edge of the glass. This thermal bridge leads, on the one hand, to heat losses in the edge region of the insulating glazing and, on the other, with high humidity and low outside temperatures, to the formation of condensation on the inner pane in the region of the spacer. To solve these problems, thermally optimized so-called “warm edge” systems in which the spacers are made of materials with lower thermal conductivity, in particular plastics, are increasingly used.

The connection between the pane and the spacer is created by an adhesive bond made of a so-called “primary sealant”, for example, polyisobutylene. In the event of a failure of this adhesive bond, this is an entry point for moisture. On the outward facing side of the spacer in the outer interpane space, a secondary sealant is usually applied as edge sealing that absorbs mechanical stress caused by climatic loads and thus ensures the stability of the insulating glazing. The outer face of the spacer must be designed such that good adhesion to the secondary sealant is ensured. Due to temperature changes over time, for example, due to solar radiation, the individual components of the insulating glazing expand and contract again when they cool down. The glass expands more than the spacer made of a polymeric material. Consequently, this mechanical movement stretches or compresses the adhesive bond and the edge seal, which can only compensate for these movements to a limited extent based on their own elasticity. Over the course of the service life of the insulating glazing, the mechanical stress described can mean a partial or complete areal detachment of an adhesive bond. This detachment of the bond between the sealant and the spacer can enable penetration of humidity into the insulating glazing, resulting in fogging in the region of the panes and a decrease in the insulating effect. The sides of the spacer that make contact with a sealant should, consequently, have the best possible adhesion to the sealant. One approach to the improvement of the adhesion to the sealant is to adjust the properties of a vapor barrier film arranged on the outside surface of the spacer.

Document EP2719533 A1 discloses for this a spacer with a film that has a thin adhesive layer of SiOx or AlOy on the side facing the secondary sealant. Apart from the thin adhesive layer, the film contains only polymeric layers, which also perform the moisture-sealing function. Among others, oriented EVOH layers serve as a barrier layer against moisture.

Document WO2019134825 A1 discloses a film for a spacer that has an outer adhesive layer in the form of an organic primer.

Document WO2015043626 A1 discloses a film for a spacer with an outer SiOx layer as a primer for adhesives and sealants. Further disclosed is an inner layer of oriented polypropylene that can be welded to the main body.

In addition to the optimized adhesion to the secondary sealant described in the prior art, the adhesion of the film applied to the spacer and the internal stability of the film are also of great importance. For high long-term stability of a spacer in an insulating glazing, both the adhesion to the secondary sealant and the primary sealant must be high, and the film itself must be stable over the long term.

It is, consequently, the object of the present invention to provide an improved spacer that does not have the above-mentioned disadvantages and to provide an improved insulating glass unit.

The object of the present invention is accomplished according to the invention by a spacer for insulating glass units according to the independent claim 1. Preferred embodiments of the invention emerge from the subclaims.

An insulating glass unit according to the invention and its use according to the invention emerge from further independent claims.

The spacer for insulating glass units according to the invention comprises at least a polymeric hollow profile extending in the longitudinal direction and having a first side wall, a second side wall arranged parallel thereto, a glazing interior wall, an outer wall, and a cavity. The cavity is surrounded by the side walls, the glazing interior wall, and the outer wall. The glazing interior wall is arranged substantially perpendicular to the side walls and connects the first side wall to the second side wall. The side walls are the walls of the hollow profile to which the outer panes of the insulating glass unit are attached. The glazing interior wall is the wall of the hollow profile that faces the inner interpane space after installation in the finished insulating glass unit. The outer wall is arranged substantially parallel to the glazing interior wall and connects the first side wall to the second side wall. The outer wall faces the outer interpane space after installation in the finished insulating glass unit.

The spacer further comprises a moisture barrier on the outer wall, the first side wall, and the second side wall of the polymeric hollow profile. The moisture barrier seals the inner interpane space against the penetration of moisture and prevents the loss of a gas contained in the inner interpane space. The moisture barrier has the form of a film with multiple layers and comprises a multi-layer system having a barrier function. This multi-layer system includes at least one polymeric layer and one inorganic barrier layer. The multi-layer system performs the barrier function of the moisture barrier and prevents the penetration of moisture into the inner interpane space. In addition, the moisture barrier includes a metallic or a ceramic outer adhesive layer having a thickness d of at least 5 nm. The outer adhesive layer faces in the direction of the external interpane space and is in contact with the secondary sealant in the finished insulating glass unit. The adhesive layer serves in particular to improve adhesion to the secondary sealant. The adhesive layer is interrupted in the transverse direction (Y) by uncoated regions. “Uncoated” means that no adhesive layer is arranged in this region of the moisture barrier. The transverse direction is perpendicular to the longitudinal direction and extends from the first side wall to the second side wall. The longitudinal direction is the direction of extension of the polymeric hollow profile. Since the adhesive layer is arranged with interruptions, depending on the manufacturing process, advantageously little material is required compared to a continuous adhesive layer. In addition, the thermal insulating properties of the edge seal are improved since the heat conduction from a pane adjacent the first side wall to a pane adjacent the second side wall is interrupted by the uncoated regions. Surprisingly, the interrupted adhesive layer improves the adhesion of the spacer to the secondary sealant such that improved long-term stability of an insulating glazing with a spacer according to the invention is achieved.

In a preferred embodiment, the adhesive layer is arranged directly adjacent a polymeric layer of the multi-layer system having a barrier function. Therefore, a polymeric layer with the interrupted adhesive layer is positioned on the side of the spacer facing outward in the direction of the outer interpane space of the spacer. Thus, the underlying inorganic barrier layer(s) is/are protected by the polymeric layer.

In another preferred embodiment, the adhesive layer having the thickness d covers an area of 30% to 95% of the moisture barrier, preferably an area of 35% to 90%, particularly preferably an area of 40% to 85%. The remaining percentage is accounted for by the uncoated regions having a thickness of 0 nm. At these coverage levels, an improvement in adhesion to the secondary sealant is achieved while, at the same time, optimizing the costs for the material of the adhesive layer.

In another preferred embodiment, the adhesive layer has a thickness d between 5 nm and 1000 nm, preferably between 10 nm and 1000 nm, particularly preferably a thickness from 15 nm to 500 nm. Particularly preferably, the adhesive layer has a thickness d between 10 nm and 300 nm, preferably a thickness from 15 nm to 100 nm, particularly preferably from 20 nm to 50 nm. Since the adhesive layer does not serve to improve the barrier effect of the moisture barrier, a comparatively low thickness is sufficient. At the same time, the preferred thickness ranges ensure that the adhesive layer is sufficiently thick to adhere securely to the film and to the secondary sealant.

In a preferred embodiment, the adhesive layer of thickness d has the form of a regular pattern. A regular distribution of the adhesive layer ensures uniformly strong adhesion over the entire area of the moisture barrier. This leads to excellent results in terms of the long-term stability of the insulating glazing having a spacer according to the invention. Preferably, the regular pattern is a regular pattern of lines and/or dots. “Regular” means that the pattern is composed of uniformly recurring elements.

In the case of a dot pattern, the dots can either consist of the adhesive layer of thickness d or of a substantially uncoated region. The term “dots” refers here to substantially circular spots. The diameter of a dot depends, among other things, on the width of the spacer and can range from 0.5 mm to 50 mm liegen. In the case of a line pattern, the lines preferably run parallel to the side walls in the direction of extension (X) of the polymeric hollow profile. Lines of the adhesive layer of the thickness d are arranged alternatingly with lines without coating. The line width (measured in the transverse direction) depends, among other things, on the width of the spacer and can range from 0.5 mm to 25 mm.

In an alternative preferred embodiment, the adhesive layer is arranged in the form of an irregular pattern. This means that the distribution of the individual elements, for example, individual dots or lines, is random. Irregular patterns can easily be produced without the use of specific masks. Despite an irregular pattern, the adhesive layer or the uncoated regions are arranged such that the interruption is implemented in the transverse direction (Y direction) along the entire polymeric hollow profile.

In another preferred embodiment, the adhesive layer is arranged in the form of flakes with a diameter between 5 nm and 50 mm, preferably between 0.5 mm and 40 mm. The term “flakes” refers to spots that have contours different from lines and dots. Within one coating, the area can change from flight to flake or remain the same. The flakes can be shaped, for example, approx. elliptical, rectangular, triangular, cruciform, or have the shape of any other polygon. The diameter of a flake is determined at its widest point. The width refers to the transverse direction (Y-direction).

Preferably, the distribution of the flakes is regular, since regular distribution of the adhesive layer ensures particularly uniform adhesion. Alternatively, the flakes are preferably arranged irregularly. This variant is particularly easy to produce without a mask.

In a preferred embodiment, the adhesive layer has a thickness of 0 nm in the uncoated regions. In this way, a particularly good improvement in the thermal insulation is achieved in the region of the moisture barrier; and, in addition, material for the adhesive layer is saved. This embodiment can be produced particularly well in a method using a mask.

In a preferred embodiment, the interruption is done by interrupted regions in the width (in the Y-direction) over at least 5 nm, preferably over at least 0.5 mm, and particularly preferably at least 2 mm. In the case of wider regions, the heat conduction through the adhesive layer is significantly interrupted such that the thermal insulating properties of the spacer are further improved.

In a preferred embodiment, the adhesive layer is a ceramic adhesive layer and includes SiOx or is made of SiOx. SiOx has particularly good adhesion to the materials of the secondary sealant and has low thermal conductivity, which further improves the thermal insulating properties of the spacer. Preferably, SiOx with x between 0.7 and 2.1, preferably between 1 and 1.5 is used.

In another preferred embodiment, the adhesive layer is a metallic adhesive layer. According to the invention, a metallic adhesive layer can comprise both pure metal as well as oxides thereof and alloys thereof. The metallic adhesive layer preferably includes or is made of aluminum, titanium, nickel, chromium, iron, or alloys or oxides thereof. These have good adhesion to the adjacent sealant. Preferred alloys are stainless-steel and TiNiCr.

Particularly preferably, the metallic adhesive layer includes or is made of an oxide of aluminum, titanium, nickel, chromium, iron. The metal oxides are characterized by particularly good adhesion to the adjacent sealant and are particularly stable over the long term. Particularly good results in terms of long-term stability have been achieved with a metallic adhesive layer of aluminum oxide, chromium oxide, or titanium oxide.

In a preferred embodiment, the metallic or ceramic adhesive layer is applied directly onto a polymeric layer of the multi-layer system having a barrier effect by means of chemical vapor deposition (CVD) or physical vapor deposition (PVD). Particularly good adhesion between the polymeric layer and the adhesive layer is thus achieved.

In a preferred embodiment, the metallic or ceramic adhesive layer is applied to a polymeric layer of the multi-layer system with the aid of a mask in the form of a pattern predetermined by the mask. This production method is particularly advantageous for regular patterns.

Preferably, a mask is applied to a polymeric layer via a roll-to-roll process. The polymeric layer can already be present as part of the multi-layer system having a barrier function or can be present individually. The polymeric layer provided with the mask can then be coated with an adhesive layer in a PVD or CVD process. This process is, for example, particularly well-suited for producing a line pattern. The mask is removed again after the end of the process.

Preferably, a mask in the form of a removable self-adhesive film with cutouts is applied to the polymeric layer to be coated. The polymeric layer can already be present as part of the multi-layer system having a barrier function or be present as an individual polymeric layer that is bonded to the rest of the multi-layer system having a barrier function in another process. The polymeric layer provided with the self-adhesive film is then coated with the material of the adhesive layer in a PVD or CVD process. The adhesive layer remains only at the locations where there is a cutout in the self-adhesive film. After the sputtering process, the self-adhesive film is removed. Where the self-adhesive film was located, there is now an uncoated region with a thickness of 0 nm such that heat conduction through the adhesive layer is interrupted.

Preferably, a mask in the form a washable ink is applied to the polymeric layer. Then, the polymeric layer is coated in a CVD or PVD process. The regions without the washable ink are thus provided with the adhesive layer, and the remaining regions remain uncoated after the ink is washed off. In other words, since no adhesive layer is arranged there, it has a thickness of 0 nm. This method is particularly flexible and can easily be used to produce a wide variety of patterns since the ink can be printed in any pattern.

In alternative preferred embodiment, the adhesive layer is applied without the aid of a mask. This is particularly economical since no special mask has to be made. Preferably, for example, a sputtering process is used for very thin layers with a layer thickness in the range of at most 10 nm. In this process, an adhesive layer is formed in the form of flakes with a thickness d of less than 10 nm and uncoated regions without an inorganic coating. Thus, an adhesive layer with irregular distribution of flakes and uncoated regions is formed. The distance between the individual flakes is preferably in the nanometer range.

Films from the prior art, such as those described in WO 2013/104507 A1, are considered for use as a multi-layer system having a barrier function.

In a preferred embodiment, the adhesive layer is arranged directly adjacent a polymeric layer of the multi-layer system having a barrier function and adjacent thereto an inorganic barrier layer such that the layer sequence, starting from the side facing the outer interpane space, is as follows: adhesive layer—polymeric layer—inorganic barrier layer. Thus, on the side of the spacer facing outward in the direction of the outer interpane space, there is a polymeric layer with the interrupted adhesive layer. Thus, the underlying inorganic barrier layer(s) is/are protected by the polymeric layer.

In a preferred embodiment, the multi-layer system having a barrier function includes at least two polymeric layers and at least two inorganic barrier layers. The inorganic barrier layers contribute substantially to the barrier function of the multi-layer system. The polymeric layers serve, on the one hand, as a carrier material and as intermediate layers between the inorganic barrier layers. On the other hand, the polymeric layers can also make a substantial contribution to the barrier function. In particular, oriented polymeric films improve the tightness of the spacer.

In a preferred embodiment, the multi-layer system having a barrier function includes exactly two polymeric layers and three inorganic barrier layers. A third inorganic barrier layer further improves the barrier effect of the moisture barrier.

In a preferred embodiment, the multi-layer system includes at least three polymeric layers and at least three inorganic barrier layers. In another preferred embodiment, the multi-layer system having a barrier function includes exactly three polymeric layers and exactly three inorganic barrier layers. Such a moisture barrier can be readily fabricated from three singly-coated films.

In a preferred embodiment, individual layers of the multi-layer system are arranged to form a layer stack with the following layer sequence: inorganic barrier layer/polymeric layer/inorganic barrier layer. Depending on the manufacturing method, the layers can be connected directly or can be connected by a bonding layer arranged therebetween. The internal stability of the moisture barrier is improved by arranging a polymeric layer between two inorganic barrier layers, since detachment of individual layers occurs less frequently than with an arrangement in which all the inorganic barrier layers are arranged adjacent one another.

A polymeric layer of the multi-layer system preferably includes polyethylene terephthalate, ethylene vinyl alcohol, oriented ethylene vinyl alcohol, polyvinylidene chloride, polyamides, polyethylene, polypropylene, oriented polypropylene, biaxially oriented polypropylene, oriented polyethylene terephthalate, biaxially oriented polyethylene terephthalate or is made of one of the polymers mentioned. Oriented polymers additionally contribute to the barrier effect.

A polymeric layer preferably has a thickness of 5 μm to 24 μm, preferably of 10 μm to 15 μm, particularly preferably of 12 μm. These thicknesses result in a multi-layer system that is particularly stable overall.

A bonding layer for bonding coated or uncoated films to form a multi-layer system preferably has a thickness of 1 μm to 8 μm, preferably of 2 μm to 6 μm. This ensures secure bonding.

An inorganic barrier layer of the multi-layer system is preferably a metallic or a ceramic barrier layer. The thickness of an individual inorganic barrier layer is preferably in the range from 20 nm to 300 nm, particularly preferably in the range from 30 nm to 100 nm.

A metallic barrier layer preferably contains or is made of metals, metal oxides, or alloys thereof. Preferably, the metallic barrier layer contains or is made of aluminum, silver, copper, their oxides or alloys. These barrier layers are characterized by particularly high tightness.

A ceramic barrier layer preferably includes or is made of a silicon oxide and/or a silicon nitride. These layers have better thermal insulating properties than metallic barrier layers and can also be implemented transparent.

In a preferred embodiment, the multi-layer system having a barrier function exclusively includes metallic barrier layers as inorganic barrier layers. This improves the long-term stability of the spacer, since thermal stresses due to different materials within the moisture barrier are better compensated than when different barrier layers are combined. Most particularly preferably, the multi-layer system having a barrier function exclusively includes aluminum layers as metallic barrier layers. Aluminum layers have particularly good sealing properties and are readily processable.

In another preferred embodiment, the multi-layer system having a barrier function exclusively includes ceramic barrier layers made of SiOx or SiN as inorganic barrier layers. Such a moisture barrier is characterized by particularly good thermal insulating properties. Particularly preferably, the outer adhesive layer is made of SiOx. Such a moisture barrier can be particularly well implemented as a transparent film.

In another preferred embodiment, the multi-layer system includes both one or more ceramic barrier layers and one or more metallic barrier layers. By combining the different barrier layers and their different properties, an optimal seal against the penetration of moisture and also against the loss of a gas filling from the inner interpane space can be achieved.

The moisture barrier is preferably arranged continuously in the longitudinal direction of the spacer, so no moisture can enter the inner interpane space in the insulating glazing along the entire circumferential spacer frame.

The moisture barrier is preferably applied such that the regions of the two side walls adjacent the glazing interior wall are free of a moisture barrier. A particularly good seal of the spacer is achieved by attaching it to the entire outer wall all the way to the side walls. The advantage of the regions on the side walls remaining free of the moisture barrier resides in an improvement of the visual appearance in the installed state. In the case of a moisture barrier adjacent the glazing interior wall, this becomes visible in the finished insulating glass unit. This is sometimes perceived as aesthetically unattractive. Preferably, the height of the region remaining free of the moisture barrier is between 1 mm and 3 mm. In this embodiment, the moisture barrier is not visible in the finished insulating glass unit.

In an alternative preferred embodiment, the moisture barrier is attached over the entire side walls. Optionally, the moisture barrier can also be arranged on the glazing interior wall. This further improves the sealing of the spacer.

The cavity of the spacer according to the invention results in a weight reduction compared to a solidly formed spacer and is available for accommodating further components, such as a desiccant.

The first side wall and the second side wall are the sides of the spacer on which the outer panes of an insulating glass unit are mounted when the spacer is installed. The first side wall and the second side wall are parallel to one another.

The outer wall of the hollow profile is the wall opposite the glazing interior wall, which faces away from the interior of the insulating glass unit (inner interpane space) toward the outer interpane space. The outer wall is preferably substantially perpendicular to the side walls. A planar outer wall that is perpendicular to the side walls in its entire course (parallel to the glazing interior wall) has the advantage that the sealing surface between the spacer and the side walls is maximized and a simpler shape facilitates the production process.

In a preferred embodiment of the spacer according to the invention, the sections of the outer wall nearest the side walls are inclined toward the side walls at an angle α (alpha) of 30° to 60° relative to the outer wall. This design improves the stability of the polymeric hollow profile. Preferably, the sections nearest the side walls are inclined at an angle α (alpha) of 45°. In this case, the stability of the spacer is further improved. The angled arrangement improves the bonding of the moisture barrier.

In a preferred embodiment, the moisture barrier is glued onto the polymeric hollow profile using a non-gassing adhesive. The difference in linear expansion between the moisture barrier and the polymeric main body can lead to thermal stresses. As a result of attaching the moisture barrier using adhesive, stresses can, if necessary, be absorbed by the elasticity of the adhesive. Suitable adhesives include thermoplastic adhesives, but also reactive adhesives, such as multicomponent adhesives. Preferably, a thermoplastic polyurethane or a polymethacrylate is used as the adhesive. This has proved particularly suitable in tests.

In a preferred embodiment of the spacer according to the invention, the polymeric hollow profile has a substantially uniform wall thickness d. The wall thickness d is preferably in the range from 0.5 mm to 2 mm. In this range, the spacer is particularly stable.

In a preferred embodiment of the spacer according to the invention, the hollow profile contains bio-based polymers, polyethylene (PE), polycarbonates (PC), polypropylene (PP), polystyrene, polyesters, polyethylene terephthalate (PET), polyethylene terephthalate glycol (PET-G), polyoxymethylene (POM), polyamides, polyamide-6,6, polybutylene terephthalate (PBT), acrylonitrile-butadiene-styrene (ABS), acrylonitrile-styrene acrylester (ASA), acrylonitrile-butadiene-styrene—polycarbonate (ABS/PC), styrene acrylonitrile (SAN), PET/PC, PBT/PC, or copolymers thereof. In a particularly preferred embodiment, the hollow profile consists substantially of one of the polymers listed.

The polymeric hollow profile is preferably glass-fiber-reinforced. The coefficient of thermal expansion of the polymeric hollow profile can be varied and adjusted by the selection of the glass fiber content in the polymeric hollow profile. By adjusting the coefficient of thermal expansion of the hollow profile and of the moisture barrier, temperature-induced stresses between the different materials and spelling of the moisture barrier can be prevented. The polymeric hollow profile preferably has a glass fiber content of 20 wt.-% to 50 wt.-%, particularly preferably of 30 wt.-% to 40 wt.-%. The glass fiber content in the polymeric hollow profile improves the strength and stability at the same time.

Glass-fiber-reinforced spacers are generally rigid spacers that are snapped together or welded at the time of assembly of a spacer frame for an insulating glass unit from individual straight pieces. The connection points have to be sealed separately with a sealant to ensure optimum sealing of a spacer frame. The spacer according to the invention can be processed particularly well due to the high stability of the moisture barrier and the particularly good adhesion to the sealant.

In an alternative preferred embodiment, the hollow profile does not contain glass fibers. The presence of glass fibers degrades the thermal insulating properties of the spacer and makes the spacer rigid and brittle. Hollow profiles without glass fibers can be bent better, eliminating the need to seal the connection points. During bending, the spacer is subjected to special mechanical loads. In particular, in the corners of a spacer frame, the moisture barrier is greatly stretched. The structure according to the invention of the spacer having a moisture barrier also enables bending of the spacer without adversely affecting the sealing of the insulating glass unit.

In another preferred embodiment, the polymeric hollow profile is made from a foamed polymer. In this case, a foaming agent is added during manufacture of the polymeric hollow profile. Examples of foamed spacers are disclosed in WO2016139180 A1. The foamed design results in reduced conduction of heat through the polymeric hollow profile and in material and weight savings compared to a solid polymeric hollow profile.

In a preferred embodiment, the glazing interior wall has at least one perforation. Preferably, multiple perforations are made in the glazing interior wall. The total number of perforations depends on the size of the insulating glass unit. The perforations in the glazing interior wall connect the cavity to the inner interpane space of an insulating glass unit, making a gas exchange between them possible. This permits absorption of atmospheric moisture by a desiccant situated in the cavity, thus preventing fogging of the panes. The perforations are preferably implemented as slits, particularly preferably as slits with a width of 0.2 mm and a length of 2 mm. The slits ensure optimum air exchange without desiccant from the cavity being able to penetrate into the inner interpane space. The perforations can be simply punched or drilled into the glazing interior wall after production of the hollow profile. Preferably, the perforations are hot punched into the glazing interior wall.

In an alternative preferred embodiment, the material of the glazing interior wall is porous or made with a plastic open to diffusion such that perforations are not required.

The polymeric hollow profile preferably has a width along the glazing interior wall of 5 mm to 55 mm, preferably of 10 mm to 20 mm. In the context of the invention, the width is the dimension extending between the side walls. The width is the distance between the surfaces of the two side walls facing away from one another. The selection of the width of the glazing interior wall determines the distance between the panes of the insulating glass unit. The exact dimension of the glazing interior wall is governed by the dimensions of the insulating glass unit and the desired size of the interpane space.

The hollow profile preferably has, along the side walls, a height of 5 mm to 15 mm, particularly preferably of 6 mm to 10 mm. In this range for the height, the spacer has advantageous stability, but is, on the other hand, advantageously inconspicuous in the insulating glass unit. In addition, the cavity of the spacer has an advantageous size for accommodating a suitable amount of desiccant. The height of the spacer is the distance between the surfaces of the outer wall and the glazing interior wall facing away from one another.

The cavity preferably contains a desiccant, preferably silica gels, molecular sieves, CaCl₂, Na₂SO₄, activated carbon, silicates, bentonites, zeolites, and/or mixtures thereof.

The invention further includes an insulating glass unit with at least a first pane, a second pane, a spacer according to the invention arranged circumferentially between the first and the second pane, an inner interpane space, and an outer interpane space. The spacer according to the invention is arranged to form a circumferential spacer frame. The first pane is attached to the first side wall of the spacer via a primary sealant, and the second pane is attached to the second side wall via a primary sealant. This means that a primary sealant is arranged between the first side wall and the first pane as well as between the second side wall and the second pane. The first pane and the second pane are arranged parallel and preferably congruently. The edges of the two panes are therefore arranged flush in the edge region, i.e., they are at the same height. The inner interpane space is delimited by the first and second pane and the glazing interior wall. The outer interpane space is defined as the space that is delimited by the first pane, the second pane, and the moisture barrier on the outer wall of the spacer. The outer interpane space is at least partially filled with a secondary sealant, with the secondary sealant making direct contact with the outer adhesive layer. The secondary sealant contributes to the mechanical stability of the insulating glass unit and absorbs part of the climatic loads that act on the edge seal.

In a preferred embodiment of the insulating glass unit according to the invention, the primary sealant covers the transition between the polymeric hollow profile and the moisture barrier such that particularly good sealing of the insulating glass unit is achieved. In this manner, the diffusion of moisture into the cavity of the spacer at the location where the moisture barrier is adjacent the plastic is reduced (less interfacial diffusion).

In another preferred embodiment of the insulating glass unit according to the invention, the secondary sealant is applied along the first pane and the second pane such that a central region of the outer wall is free of secondary sealant. The “central region” refers to the region arranged centrally relative to the two outer panes, in contrast to the two outer regions of the outer wall that are adjacent the first pane and the second pane. In this manner, good stabilization of the insulating glass unit is obtained, while, at the same time, material costs for the secondary sealant are saved. At the same time, this arrangement can be easily produced by applying two strands of secondary sealant on the outer wall in the outer region adjacent the outer panes in each case.

In another preferred embodiment, the secondary sealant is attached such that the entire outer interpane space is completely filled with secondary sealant. This results in maximum stabilization of the insulating glass unit.

Preferably, the secondary sealant contains polymers or silane-modified polymers, particularly preferably organic polysulfides, silicones, hot melts, polyurethanes, room-temperature-vulcanizing (RTV) silicone rubber, peroxide-vulcanizing silicone rubber, and/or addition-vulcanizing silicone rubber. These sealants have a particularly good stabilizing effect.

The primary sealant preferably contains a polyisobutylene. The polyisobutylene can be a cross-linking or non-cross-linking polyisobutylene.

The first pane and the second pane of the insulating glass unit preferably contain glass, ceramic, and/or polymers, particularly preferably quartz glass, borosilicate glass, soda lime glass, polymethyl methacrylate, or polycarbonate.

The first pane and the second pane have a thickness of 2 mm to 50 mm, preferably 3 mm to 16 mm, with the two panes possibly even having different thicknesses.

In a preferred embodiment of the insulating glass unit according to the invention, the spacer frame consists of one or a plurality of spacers according to the invention. For example, it can be one spacer according to the invention that is bent to form a complete frame. It can also be a plurality of spacers according to the invention that are linked to one another via one or more plug connectors. The plug connectors can be implemented as linear connectors or corner connectors. Such corner connectors can, for example, be implemented as plastic molded parts with a seal, in which two mitered spacers abut.

In principle, a wide variety of geometries of the insulating glass unit are possible, for example, rectangular, trapezoidal, and rounded shapes. To produce round geometries, the spacer according to the invention can, for example, be bent in the heated state.

In another embodiment, the insulating glazing includes more than two panes. In this case, the spacer can include grooves in which at least one additional pane is arranged. Multiple panes could also be laminated glass panes.

The invention further includes the use of the insulating glass unit according to the invention as building interior glazing, building exterior glazing, and/or façade glazing.

In the following, the invention is explained in detail with reference to drawings. The drawings are purely schematic representations and are not to scale. They in no way restrict the invention. They depict:

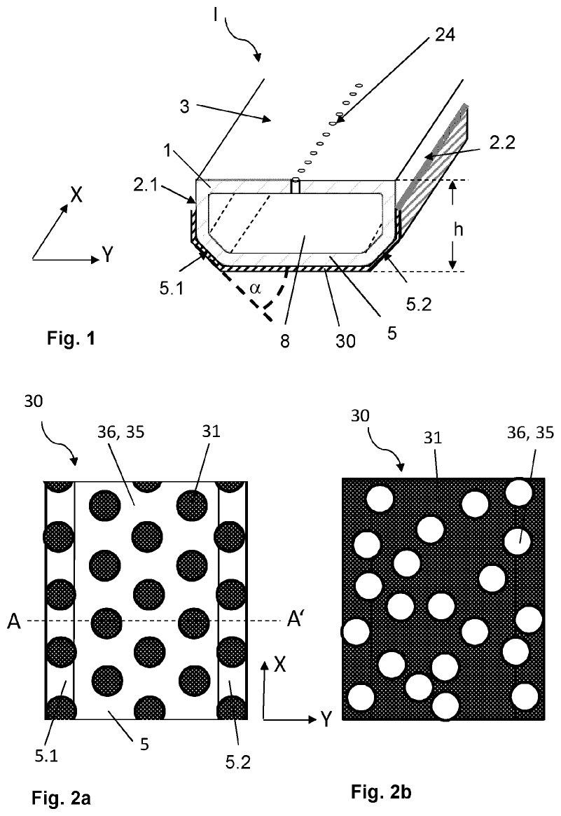

FIG. 1 a cross-section of a possible embodiment of a spacer according to the invention,

FIG. 2a,b in each case, a plan view of the moisture barrier of a possible embodiment of a spacer according to the invention,

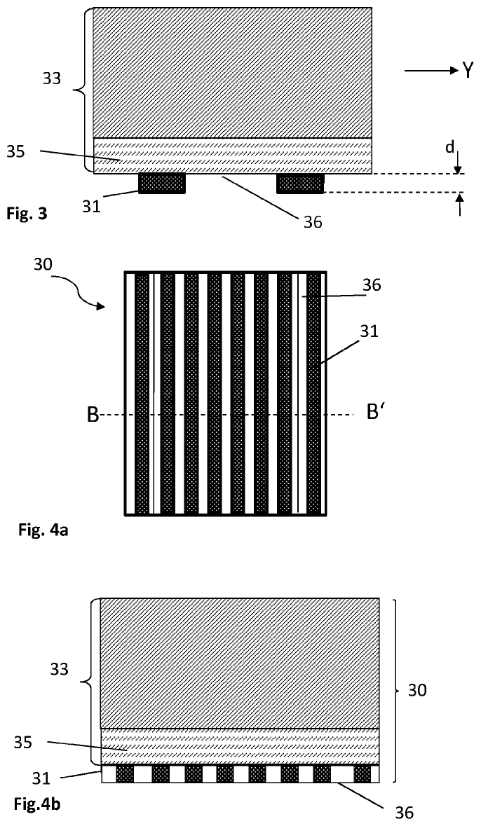

FIG. 3 a cross-section along the line A-A′ through the moisture barrier depicted in FIG. 2a,

FIG. 4a, b a plan view of the moisture barrier of a possible embodiment of a spacer according to the invention (a) and a cross-section along the line B-B′ through the moisture barrier depicted in FIG. 4a,

FIG. 5a, b a plan view of the moisture barrier of a possible embodiment of a spacer according to the invention (a) and a cross-section along the line C-C′ through the moisture barrier depicted in FIG. 5a,

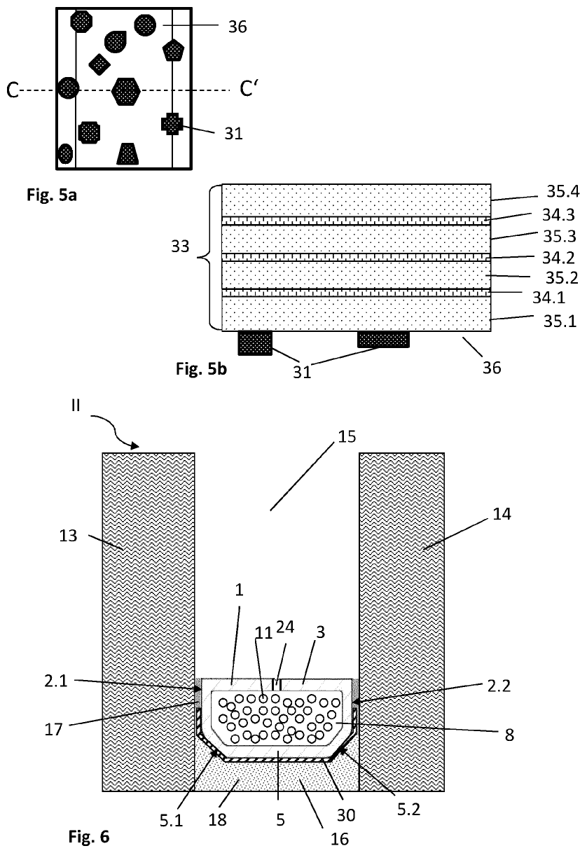

FIG. 6 a cross-section of a possible embodiment of an insulating glass unit according to the invention.

FIG. 1 depicts a cross-section through a possible spacer I according to the invention. The spacer comprises a polymeric hollow profile 1 extending in the longitudinal direction (X) and having a first side wall 2.1, a side wall 2.2 running parallel thereto, a glazing interior wall 3, and an outer wall 5. The glazing interior wall 3 is perpendicular to the side walls 2.1 and 2.2 and connects the two side walls. The outer wall 5 is opposite the glazing interior wall 3 and connects the two side walls 2.1 and 2.2. The outer wall 5 is substantially perpendicular to the side walls 2.1 and 2.2. However, the sections 5.1 and 5.2 of the outer wall 5 nearest side walls 2.1 and 2.2 are inclined at an angle α (alpha) of approx. 45° relative to the outer wall 5 in the direction of the side walls 2.1 and 2.2. The angled geometry improves the stability of the hollow profile 1 and enables better bonding with a moisture barrier 30. The hollow profile 1 is a polymeric hollow profile, made substantially of polypropylene with 20 wt.-% glass fibers. The wall thickness of the hollow profile is 1 mm. The wall thickness is substantially the same everywhere. This improves the stability of the hollow profile and simplifies its manufacture. The hollow profile 1 has, for example, a height h of 6.5 mm and a width of 15.5 mm. The width extends in the Y direction from the first side wall 2.1 to the second side wall 2.2. The outer wall 5, the glazing interior wall 3, and the two side walls 2.1 and 2.2 enclose the cavity 8. A gas-tight and moisture-tight moisture barrier 30 is arranged on the outer wall 5 and on part of the first side wall 2.1 and part of the second side wall 2.2. The regions of the first side wall 2.1 and the second side wall 2.2 adjacent the glazing interior wall 3 remain free of moisture barrier 30. Measured from the glazing interior wall 3, this is a 1.9-mm-wide strip that remains free. The moisture barrier 30 can, for example, be attached to the polymeric hollow profile 1 with a polymethacrylate adhesive. The embodiments depicted in the following figures are suitable as a moisture barrier 30. The cavity 8 can accommodate a desiccant 11. Perforations 24 that establish a connection to the inner interpane space in the insulating glass unit are made in the glazing interior wall 3. The desiccant 11 can then absorb moisture from the inner interpane space 15 via the perforations 24 in the glazing interior wall 3.

FIG. 2a depicts a plan view of the side of a moisture barrier 30 facing outward toward the outer interpane space, as it can be applied on the spacer I in FIG. 1. The moisture barrier 30 has an outer adhesive layer 31 that is interrupted by multiple uncoated regions 36 in which the material of the underlying polymeric layer 35 is exposed. In this case, the polymeric layer 35 is made of PET. FIG. 3 depicts a cross-section along the line A-A′. The outer adhesive layer 31 has a thickness d of 30 nm and consists of an SiOx layer that was applied in a PVD process using a mask. The adhesive layer 31 of thickness d is interrupted by uncoated regions 36. No adhesive layer is arranged in the uncoated regions. The mask is preferably adhered during the process such that no coating material can penetrate between the mask and the polymeric layer. Since the adhesive layer 31 was produced by a PVD process with a mask, the thickness of the adhesive layer 31 is substantially equal to the thickness d over the entire area of the moisture barrier. The adhesive layer 31 is interrupted in the transverse direction (Y) by the uncoated regions 36. As is depicted in FIG. 2a, the adhesive layer 31 is in the form of a regular dot pattern. The regular arrangement of the adhesive layer 31 ensures particularly uniform adhesion to the secondary sealant. The dots have a diameter of about 4 mm.

FIG. 2b depicts a plan view, as in FIG. 2a, of another embodiment of a moisture barrier 30. Here, instead of a regular dot pattern, the adhesive layer 31 is in the form of an irregular dot pattern. In this case, the uncoated regions 36 have the form of dots with a diameter of 3 mm, which are irregularly distributed. In the uncoated regions 36, the adhesive layer has a thickness of 0 nm. It is produced by applying a washable ink to a PET layer 35 at the locations where the uncoated regions 36 are provided. The PET layer provided with the ink was then sputtered with a 10-nm-thick aluminum oxide layer. After the sputtering process, the washable ink was washed off again to create an adhesive layer 31 with uncoated regions 36. Since no aluminum oxide layer is arranged in the uncoated regions due to the production method used, the heat conduction from the first side wall 2.1 to the second side wall 2.2 is interrupted, which contributes to the improvement of the thermal insulating properties of the spacer. Despite the irregular distribution of the uncoated regions, it is ensured that the adhesive layer 31 is interrupted in the transverse direction (Y direction) by the uncoated regions. This interruption is realized by uncoated regions along the entire hollow profile in the longitudinal direction.

FIG. 4a and FIG. 4b depict an example of a moisture barrier 30 that was coated with an aluminum oxide layer 31 with a thickness d of 30 nm in a CVD process. In this process, a mask with a regular line pattern of 1-mm-wide lines of adhesive layer and uncoated regions was adhered on the polymeric layer made of PET and the PET layer 35 provided with the mask was coated. After the coating process, the mask was removed again such that a uniform line pattern was obtained, which has substantially the same thickness of the adhesive layer d over the entire moisture barrier. This is advantageous for uniform adhesion to the secondary sealant. Various barrier films from the prior art are suitable as the multi-layer system 33, as described, for example, in WO 2013/104507 A1, wherein the polymeric layer 35 adjacent the adhesive layer is a PET layer.

FIGS. 5a and 5b depict a moisture barrier 30 of a spacer I according to the invention. As an outer adhesive layer 31, a nonuniformly thick aluminum layer 31 is applied via a sputtering process. The thickness d of the adhesive layer varies between 5 nm and 10 nm. In between, there are uncoated regions 36. The individual flakes have different geometries, as indicated by different geometric areas. Adjacent this, a multi-layer system having a barrier function 33 and consisting of four polymeric layers 35.1, 35.2, 35.3, and 35.4 and three inorganic barrier layers 34.1, 34.2, and 34.3 is arranged. The inorganic barrier layers are, in each case, 50-nm-thick aluminum layers. The polymeric layers 35.1, 35.2, 35.3, and 35.4 are, in each case, 12-μm-thick PET layers. The polymeric layers 35.2, 35.3, and 35.4 are, in each case, directly bonded to an aluminum layer. A 3-μm-thick bonding layer of a polyurethane adhesive is arranged between the first polymeric layer 35.1 and the first aluminum layer 34.1. Likewise, a bonding layer is arranged between the second aluminum layer 34.2 and the second polymeric layer 35.2. Between the third aluminum layer 34.3 and the third polymeric layer 35.3, a bonding layer is likewise arranged. Thus, three binding layers are arranged in the entire stack of the moisture barrier 30. The moisture barrier can thus be produced by laminating four polymer films coated on one side: one PET film having a patterned coating on one side and three PET films coated flat on one side. By orienting the third aluminum layer 34.3 to face the layer stack, the third aluminum layer 34.3 is protected against mechanical damage. The three thin aluminum layers ensure a high moisture density of the moisture barrier and thus of the spacer.

FIG. 6 depicts a cross-section of the edge region of an insulating glass unit II according to the invention with the spacer I shown in FIG. 1. The first pane 13 is connected to the first side wall 2.1 of the spacer I via a primary sealant 17, and the second pane 14 is attached to the second side wall 2.2 via the primary sealant 17. The primary sealant 17 is substantially a cross-linking polyisobutylene. The inner interpane space 15 is situated between the first pane 13 and the second pane 14 and is delimited by the glazing interior wall 3 of the spacer I according to the invention. The inner interpane space 15 is filled with air or with an inert gas such as argon. The cavity 8 is filled with a desiccant 11, for example, molecular sieve. The cavity 8 is connected to the inner interpane space 15 via perforations 24 in the glazing interior wall 3. A gas exchange between the cavity 8 and the inner interpane space 15 takes place through the perforations 24 in the glazing interior wall 3, with the desiccant 11 absorbing the atmospheric humidity out of the inner interpane space 15. The first pane 13 and the second pane 14 protrude beyond the side walls 2.1 and 2.2 creating an outer interpane space 16 that is situated between the first pane 13 and the second pane 14 and is delimited by the outer wall 5 with the moisture barrier 30 of the spacer. The edge of the first pane 13 and the edge of the second pane 14 are arranged at the same level. The outer interpane space 16 is filled with a secondary sealant 18. In the example, the secondary sealant 18 is a polysulfide. Polysulfides absorb the forces acting on the edge seal particularly well and thus contribute to high stability of the insulating glass unit II. The adhesion of polysulfides to the adhesive layer of the spacer according to the invention is excellent. The first pane 13 and the second pane 14 are made of soda lime glass having a thickness of 3 mm.

List of Reference Characters

| | |
|---|---|
| I | spacer |
| II | insulating glass unit, insulating glazing |
| 1 | hollow profile |
| 2.1 | first side wall |
| 2.2 | second side wall |
| 3 | glazing interior wall |
| 5 | outer wall |
| 5.1, 5.2 | the sections of the outer wall |
| | nearest the side walls |
| 8 | cavity |
| 11 | desiccant |
| 13 | first pane |
| 14 | second pane |
| 15 | inner interpane space |
| 16 | outer interpane space |
| 17 | primary sealant |
| 18 | secondary sealant |
| 24 | perforation in the glazing interior wall |
| 30 | moisture barrier |
| 31 | adhesive layer |
| 33 | multi-layer system having a barrier function |
| 34 | inorganic barrier layer |
| 35 | polymeric layer |
| 36 | uncoated regions of the moisture barrier |
| d | thickness of the adhesive layer |
| X | longitudinal direction, direction of |
| | extension of the hollow profile |
| Y | transverse direction |

1. A spacer for insulating glass units, comprising:
a polymeric hollow profile extending in a longitudinal direction and comprising
a first side wall and a second side wall arranged parallel thereto, a glazing interior wall, which connects the first and second side walls to one another;
an outer wall, which is arranged substantially parallel to the glazing interior wall and connects the first and second side walls to one another;
a cavity, which is surrounded by the first and second side walls, the glazing interior wall, and the outer wall,
a moisture barrier on the first side wall, the outer wall, and the second side wall of the polymeric hollow profile, wherein the moisture barrier comprises
a multi-layer system having a barrier function comprising at least one polymeric layer and an inorganic barrier layer,
a metallic or ceramic outer adhesive layer, wherein the metallic or ceramic outer adhesive layer has a thickness d of at least 5 nm,
the metallic or ceramic outer adhesive layer is interrupted in a transverse direction by uncoated regions.

2. The spacer according to claim 1, wherein the metallic or ceramic outer adhesive layer covers an area of 30% to 95% of the moisture barrier.

3. The spacer according to claim 1, wherein the metallic or ceramic outer adhesive layer has a thickness d between 10 nm and 1000 nm.

4. The spacer according to claim 1, wherein the metallic or ceramic outer adhesive layer is arranged in the form of a regular pattern.

5. The spacer according to claim 1, wherein the metallic or ceramic outer adhesive layer is arranged in the form of lines.

6. The spacer according to claim 1, wherein the metallic or ceramic outer adhesive layer is arranged in the form of flakes with a diameter between 5 nm and 50 mm.

7. The spacer according to claim 6, wherein the flakes are arranged irregularly.

8. The spacer according to claim 1, wherein the uncoated regions have a thickness of 0 nm.

9. The spacer according to claim 1, wherein the metallic or ceramic outer adhesive layer is a ceramic adhesive layer and includes or is made of SiOx.

10. The spacer according to claim 1, wherein the metallic or ceramic outer adhesive layer is a metallic adhesive layer and includes or is made of aluminum, titanium, nickel, chromium, iron, alloys thereof, and/or oxides thereof.

11. The spacer according to claim 10, wherein the metallic or ceramic outer adhesive layer is made substantially of a metal oxide.

12. The spacer according to claim 1, wherein the metallic or ceramic outer adhesive layer is applied by chemical vapor deposition (CVD) or physical vapor deposition (PVD).

13. An insulating glass unit, comprising a first pane, a second pane, a spacer according to claim 1 arranged circumferentially between the first pane and the second pane, wherein
the first pane is attached to the first side wall via a primary sealant,
the second pane is attached to the second side wall via a primary sealant,
an inner interpane space is delimited by the glazing interior wall, the first pane, and the second pane,
an outer interpane space is delimited by the moisture barrier attached on the outer wall and the first pane and the second pane,
a secondary sealant is arranged in the outer interpane space wherein the secondary sealant is in contact with the metallic or ceramic outer adhesive layer.

14. A method comprising manufacturing a building interior glazing, building exterior glazing, and/or façade glazing with an insulating glazing according to claim 13.

15. The spacer according to claim 2, wherein the metallic or ceramic outer adhesive layer covers an area of 40% to 55% of the moisture barrier.

16. The spacer according to claim 3, wherein the thickness d is between 15 nm and 100 nm.

17. The spacer according to claim 4, wherein the metallic or ceramic outer adhesive layer is arranged in the form of a regular pattern of lines and/or dots.

18. The spacer according to claim 5, wherein the metallic or ceramic outer adhesive layer is arranged in the form of lines that run parallel to the side walls.

19. The spacer according to claim 6, wherein the diameter is between 0.5 nm and 40 mm.

20. The spacer according to claim 11, wherein the metal oxide is aluminum oxide, chromium oxide, or titanium oxide.
